(19) United States
(12) Patent Application Publication
(10) Pub. No.: US 2019/0245284 A1
(43) Pub. Date: Aug. 8, 2019

(54) ELECTRONIC COMPONENT AND SUBSTRATE

(71) Applicant: FUJITSU LIMITED, Kawasaki-shi (JP)

(72) Inventors: Takahide Mukoyama, Kamakura (JP); Tetsuro Yamada, Kawasaki (JP); Mitsuhiko Sugane, Ichikawa (JP); YOSHIYUKI HIROSHIMA, Nakano (JP); Kohei Choraku, Yokohama (JP); Kazuki TAKAHASHI, Kawasaki (JP); AKIKO MATSUI, Meguro (JP); Shigeo Iriguchi, Kawasaki (JP)

(73) Assignee: FUJITSU LIMITED, Kawasaki-shi (JP)

(21) Appl. No.: 16/264,881

(22) Filed: Feb. 1, 2019

(30) Foreign Application Priority Data
Feb. 8, 2018 (JP) 2018-021338

(51) Int. Cl. H01R 12/58; H01R 12/71; H01R 12/72; H01R 12/73

(52) U.S. Cl. CPC H01R 12/585; H01R 12/737; H01R 12/724; H01R 12/716

(57) ABSTRACT

An electronic component includes: a first terminal that is inserted into a first through hole in a substrate; and a second terminal that is inserted into a second through hole in the substrate, wherein a length of the first terminal from a first end that is inserted into the first through hole to a second end is longer than a length of the second terminal from a third end that is inserted into the second through hole to a fourth end, and a cross sectional area of a portion of the first terminal positioned on a side of the second end with respect to a first joined portion is larger than a cross sectional area of a portion of the second terminal positioned on a side of the fourth end with respect to a second joined portion.

### CROSS-REFERENCE TO RELATED APPLICATION

This application is based upon and claims the benefit of priority of the prior Japanese Patent Application No. 2018-21338, filed on Feb. 8, 2018, the entire contents of which are incorporated herein by reference.

### FIELD

The embodiments discussed herein are related to an electronic component and a substrate.

### BACKGROUND

Electronic components having terminals inserted into and joined to through holes formed in a substrate are provided.

Related art is disclosed in Japanese Laid-Open Patent Publication No. 2008-146880 and Japanese Laid-Open Patent Publication No. 02-94532.

### SUMMARY

According to an aspect of the embodiments, an electronic component includes: a first terminal that is inserted into and joined to a first through hole formed in a substrate; and a second terminal that is inserted into and joined to a second through hole having an inner diameter that is the same as an inner diameter of the first through hole and formed in the substrate, wherein a length of the first terminal from a first end that is inserted into the first through hole to a second end that is opposite to the first end is longer than a length of the second terminal from a third end that is inserted into the second through hole to a fourth end that is opposite to the third end, and a cross sectional area of a portion of the first terminal positioned on a side of the second end with respect to a first joined portion at which the first terminal is joined to the first through hole is larger than a cross sectional area of a portion of the second terminal positioned on a side of the fourth end with respect to a second joined portion at which the second terminal is joined to the second through hole.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a cross-sectional view of an electronic device according to a first embodiment;

FIG. 2A is a plan view of a connector of the first embodiment as viewed from the front end side;

FIG. 2B is a cross-sectional view taken along line A-A of FIG. 2A;

FIG. 2C is a cross-sectional view taken along line B-B of FIG. 2B;

FIG. 3A is an enlarged cross-sectional view of a connecting portion between the connector and a substrate of the first embodiment;

FIG. 3B is a plan view of FIG. 3A as viewed from a direction A;

FIG. 4A is a cross-sectional view of a connector of comparative example 1;

FIG. 4B is a cross-sectional view taken along line A-A of FIG. 4A;

FIG. 5A is an enlarged cross-sectional view of a connecting portion between the connector and a substrate of comparative example 1;

FIG. 5B is a plan view of FIG. 5A as viewed from a direction A.

FIG. 6A is a cross-sectional view of a connector in a second embodiment;

FIG. 6B is a cross-sectional view taken along line A-A of FIG. 6A;

FIG. 7A is an enlarged cross-sectional view of a connecting portion between the connector and a substrate of the second embodiment;

FIG. 7B is a plan view of FIG. 7A as viewed from a direction A;

FIG. 8A is a cross-sectional view of a connector according to a third embodiment;

FIG. 8B is a cross-sectional view taken along line A-A of FIG. 8A;

FIG. 8C is a cross-sectional view taken along line B-B of FIG. 8A;

FIG. 9 is an enlarged cross-sectional view of a connecting portion between the connector and a substrate of the third embodiment;

FIG. 10A is a cross-sectional view of a connector of a fourth embodiment;

FIG. 10B is a cross-sectional view taken along line A-A of FIG. 10A; and

FIG. 10C is a cross-sectional view taken along line B-B of FIG. 10A.

### DESCRIPTION OF EMBODIMENTS

An example of an electronic components having terminals inserted into and joined to through holes formed in a substrate is a right angle type connector. For example, a right angle type connector with improved reliability of connection by making the diameter of a second terminal that is longer than a first terminal larger than that of the first terminal is provided. Further, a semiconductor package including a power supply line pin having a cross sectional area larger than that of a signal line pin is provided.

In an electronic component having a first terminal and a second terminal inserted into and joined to through holes of the substrate, when the lengths of the first terminal and the second terminal are different, a difference may be generated between the electrical resistances of the first terminal and the second terminal. In this case, a difference may be generated between the magnitude of the current flowing through the first terminal and the magnitude of the current flowing through the second terminal.

Hereinafter, embodiments of the present invention will be described with reference to the drawings.

### First Embodiment

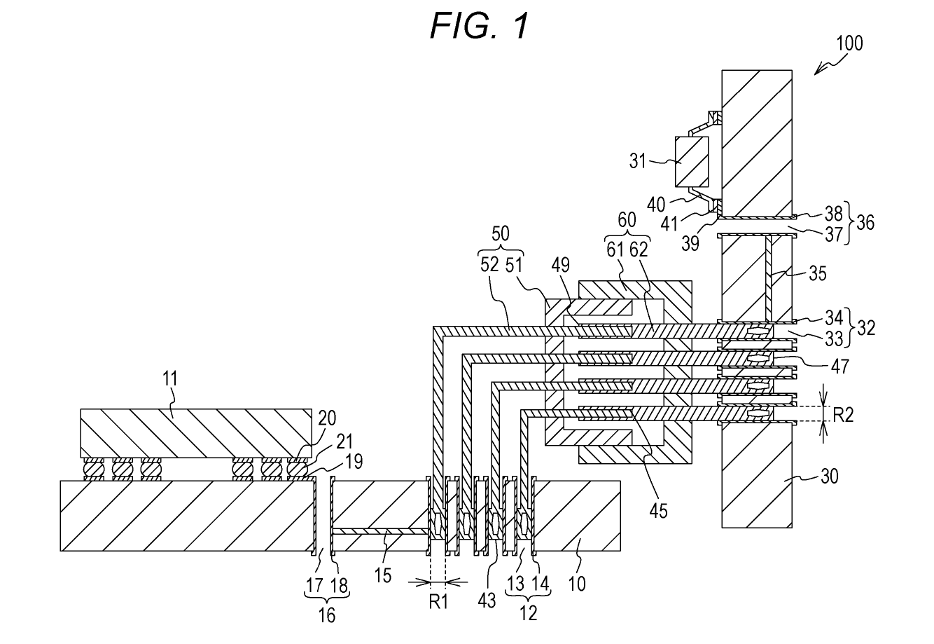

As illustrated in FIG. 1, an electronic device 100 includes a substrate 10, a substrate 30, a connector 50, and a connector 60. The substrates 10 and 30 are, for example, printed boards, and are formed from an insulating material such as a thermoplastic resin, a thermosetting resin, or a ceramic. The connector 50 is, for example, a male connector, and the connector 60 is, for example, a female connector. The connector 50 is mounted on the substrate 10, and the connector 60 is mounted on the substrate 30. The connector 50 and the connector 60 are fitted with each other. Thus, the substrate 10 and the substrate 30 are electrically coupled.

A semiconductor component 11 is mounted on the substrate 10. The semiconductor component 11 is a semiconductor chip such as a Large Scale Integration (LSI), for example. An electronic component other than the semiconductor component 11 may be mounted. A plurality of through holes 12 is formed in the substrate 10. All of the inner diameters R1 of the plurality of through holes 12 are of the same length. The phrase, the inner diameters R1 are of the same length, may also mean that the inner diameter R1 which is different by a degree of manufacturing error is included in the inner diameters R2 which are of the same length. Each of the through holes 12 includes a hole 13 passing through the substrate 10 and a metal layer 14 formed on the side wall of the hole 13. The metal layer 14 is formed from, for example, copper. The through holes 12 are coupled to through holes 16 formed in the substrate 10 via internal wirings 15 formed inside the substrate 10. When each of the plurality of internal wirings 15 is connected to corresponding one of the plurality of through holes 12, at least one of the pattern widths and the lengths of the plurality of internal wirings 15 are adjusted such that almost the same magnitude of current flows through the plurality of internal wirings 15. Each of the through holes 16 includes a hole 17 passing through the substrate 10 and a metal layer 18 formed on the side wall of the hole 17. The metal layer 18 is formed from, for example, copper. The through hole 16 is connected to an electrode 19 formed on the upper surface of the substrate 10. The semiconductor component 11 is mounted on the substrate 10 by a solder ball 21 joining an electrode 20 of the semiconductor component 11 to the electrode 19 of the substrate 10. Although the plurality of through holes 16 are formed in the substrate 10, other through holes are not illustrated in FIG. 1 for clarity of the drawing.

The connector 50 has a housing 51 and a plurality of terminals (leads) 52 passing through the housing 51. The housing 51 is formed from an insulating material such as a resin or a plastic, for example. The terminals 52 are formed from a conductive material such as brass or pure copper. The surfaces of the terminals 52 may be plated. One ends 43 of the terminals 52 project from the rear end of the housing 51, and are inserted into and joined to the through holes 12 formed in the substrate 10. The other ends 45 of the terminals 52 project from the front end of the housing 51. The terminals 52 extend in a direction substantially parallel to the upper surface of the substrate 10 from the rear end of the housing 51 and then bend toward the substrate 10 to extend in a direction substantially perpendicular to the upper surface of the substrate 10. As described above, the connector 50 is a right angle type connector.

A power supply unit 31 is mounted on the substrate 30. The power supply unit 31 is, for example, a DC/DC converter, but may be a unit of a different type. A plurality of through holes 32 are formed in the substrate 30. All of the inner diameters R2 of the plurality of through holes 32 are of the same length. The phrase, the inner diameters R2 are of the same length, may also mean that the inner diameter R2 which is different by a degree of manufacturing error is included in the inner diameters R2 which are of the same length. Each of the through holes 32 includes a hole 33 passing through the substrate 30 and a metal layer 34 formed on the side wall of the hole 33. The metal layer 34 is formed from, for example, copper. The through hole 32 is coupled to a through hole 36 formed in the substrate 30 via an internal wiring 35 formed inside the substrate 30. When each of a plurality of internal wirings 35 is coupled to corresponding one of the plurality of through holes 32, at least one of the pattern widths and the lengths of the plurality of internal wirings 35 are adjusted such that almost the same amount of current flows through the plurality of internal wirings 35. The through hole 36 includes a hole 37 passing through the substrate 30 and a metal layer 38 formed on the side wall of the hole 37. The metal layer 38 is formed from, for example, copper. The through hole 36 is coupled to an electrode 39 formed on the upper surface of the substrate 30. The power supply unit 31 is mounted on the substrate 30 by a solder 41 joining a terminal 40 of the power supply unit 31 to the electrode 39 of the substrate 30.

The connector 60 has a housing 61 and a plurality of terminals (leads) 62 passing through the housing 61. The housing 61 is formed from an insulating material such as a resin or a plastic, for example. The terminals 62 are formed from a conductive material such as brass or pure copper. The surfaces of the terminals 62 may be plated. One ends 47 of the terminals 62 project from the rear end of the housing 61, and are inserted into and joined to the through holes 32 formed in the substrate 30. The other ends 49 of the terminals 62 project from the front end of the housing 61. The terminals 62 extend in a direction substantially perpendicular to the upper surface of the substrate 30 from the one ends to the other ends. As described above, the connector 60 is a straight type connector.

The other ends 45 of the terminals 52 of the connector 50 projecting from the front end of the housing 51 are inserted into the other ends 49 of the terminals 62 of the connector 60 projecting from the front end of the housing 61. Thus, the connector 50 and the connector 60 are fitted with each other. Therefore, current flowing from the power supply unit 31 when a power supply voltage is applied flows from the substrate 30 to the substrate 10 via the connectors 50 and 60, and is supplied to the semiconductor component 11. For example, the terminals 52 of the connector 50 and the terminals 62 of the connector 60 are power supply terminals to which current is supplied from the power supply unit 31.

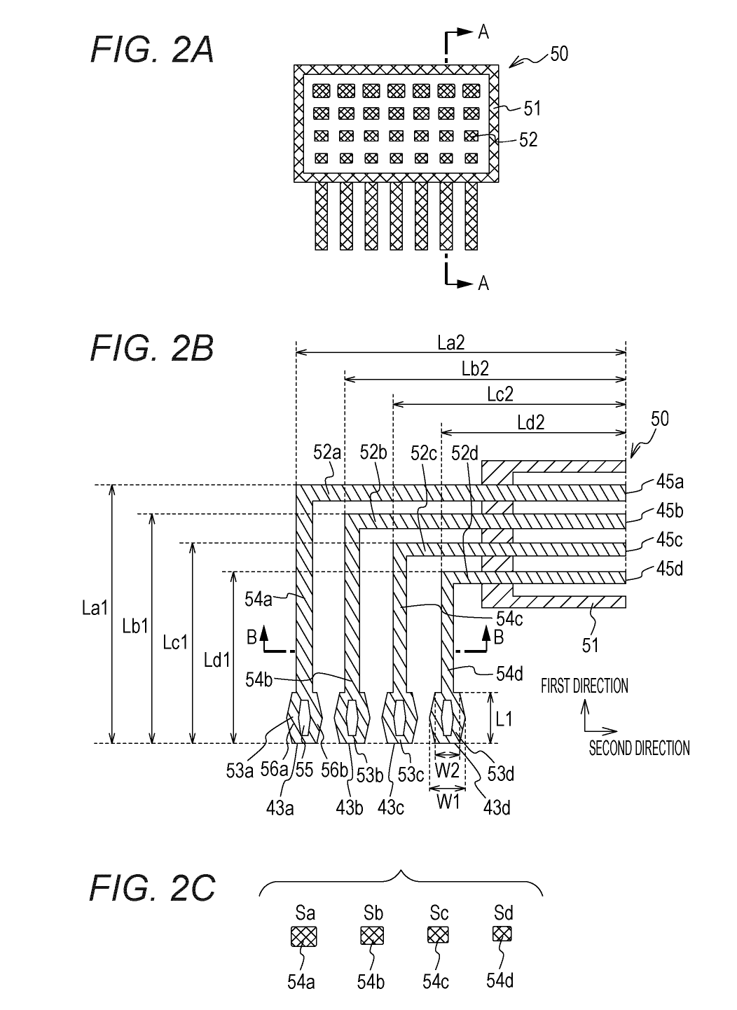

FIG. 2A is a plan view of the connector 50 according to the first embodiment as viewed from the front end side, FIG. 2B is a cross-sectional view taken along line A-A of FIG. 2A, and FIG. 2C is a cross-sectional view taken along line B-B of FIG. 2B. As illustrated in FIG. 2A, in the connector 50, the plurality of terminals 52 passing through the housing 51 is provided in a lattice shape.

Since the connector 50 is a right angle type connector as illustrated in FIG. 2B, terminals 52a to 52d arranged in the height direction of the housing 51 have lengths that are different from each other. In a case where the terminals 52a, 52b, 52c, and 52d are coupled to the housing 51 in this order from the upper side, the lengths of the terminals 52a, 52b, 52c, and 52d become shorter in this order.

The terminals 52a to 52d are, for example, press-fit terminals. The terminals 52a to 52d have wide press-in portions (press-fit portions) 53a to 53d formed on one ends 43a to 43d projecting from the rear end of the housing 51 and extending portions 54a to 54d that extend toward the other ends 45a to 45d from the press-in portions 53a to 53d. The extending portions 54a to 54d extend in a direction substantially parallel to the upper surface of the substrate 10 from the rear end of the housing 51 and then bend toward the substrate 10 to extend in a direction substantially perpendicular to the upper surface of the substrate 10.

All of the press-in portions 53a to 53d have the same shape and the same size, and each of the press-in portions 53a to 53d includes an open hole 55 formed in the center and elastic portions 56a and 56b formed on both sides with respect to the open hole 55. The phrase, the press-in portions 53a to 53d have the same shape and the same size, may also mean that the press-in portions 53a to 53d which have different shapes and sizes by a degree of manufacturing error are included in the press-in portions 53a to 53d which have the same shape and the same size. Here, the direction in which the extending portions 54a to 54d extend from the press-in portions 53a to 53d is referred to as a first direction, and the direction which intersects with (for example, orthogonal to) the first direction is referred to as a second direction. All of the lengths L1 of the press-in portions 53a to 53d in the first direction are the same. All of the widths W1 of portions of the press-in portions 53a to 53d located in the center thereof in the first direction are the same. The widths W1 are from the elastic portions 56a through the open holes 55 to the elastic portions 56b in the second direction. The phrase, the lengths L1 are the same and the widths W1 are the same, may also mean that they are different by a degree of manufacturing error.

All of the widths W2 of portions of the press-in portion 53a to 53d located at the boundaries between the press-in portions 53a to 53d and the extending portions 54a to 54d are the same, and are larger than all of the widths of the extending portions 54a to 54d at the boundaries. For example, the boundaries between the press-in portions 53a to 53d and the extending portions 54a to 54d have a stepped structure. The phrase, the widths W2 are the same, may also mean that the widths W2 which are different by a degree of manufacturing error are included in the widths W2 which are the same.

The extending portions 54a to 54d have lengths that are different from each other and widths that are different from each other. As described above, the lengths of the terminal 52a, the terminal 52b, the terminal 52c, and the terminal 52d become shorter in this order. Here, the length of the terminal 52a is defined as (La1+La2), the length of the terminal 52b is defined as (Lb1+Lb2), the length of the terminal 52c is defined as (Lc1+Lc2), and the length of the terminal 52d is defined as (Ld1+Ld2). In this case, a relationship, the length of the terminal 52a (La1+La2)>the length of the terminal 52b (Lb1+Lb2)>the length of the terminal 52c (Lc1+Lc2)>the length of the terminal 52d (Ld1+Ld2), is satisfied.

The terminals 52a to 52d include the press-in portions 53a to 53d and the extending portions 54a to 54d. Thus, the length of the extending portion 54a is (La1+La2−L1), the length of the extending portion 54b is (Lb1+Lb2−L1), the length of the extending portion 54c is (Lc1+Lc2−L1), and the length of the extending portion 54d is (Ld1+Ld2−L1). Therefore, a relationship, the length of the extending portion 54a (La1+La2−L1)>the length of the extending portion 54b (Lb1+Lb2−L1)>the length of the extending portion 54c (Lc1+Lc2−L1)>the length of the extending portion 54d (Ld1+Ld2−L1), is satisfied.

As illustrated in FIG. 2C, the extending portions 54a to 54d having larger cross sectional areas have larger lengths. For example, the cross sectional areas of the extending portion 54a, the extending portion 54b, the extending portion 54c, and the extending portion 54d become smaller in this order. Here, the cross sectional area of the extending portion 54a is defined as Sa, the cross sectional area of the extending portion 54b is defined as Sb, the cross sectional area of the extending portion 54c is defined as Sc, and the cross sectional area of the extending portion 54d is defined as Sd. In this case, a relationship, the cross sectional area Sa of the extending portion 54a>the cross sectional area Sb of the extending portion 54b>the cross sectional area Sc of the extending portion 54c>the cross sectional area Sd of the extending portion 54d, is satisfied. The cross sectional area of whole of the extending portion 54a is substantially constant at Sa. The same applies to the extending portions 54b to 54d.

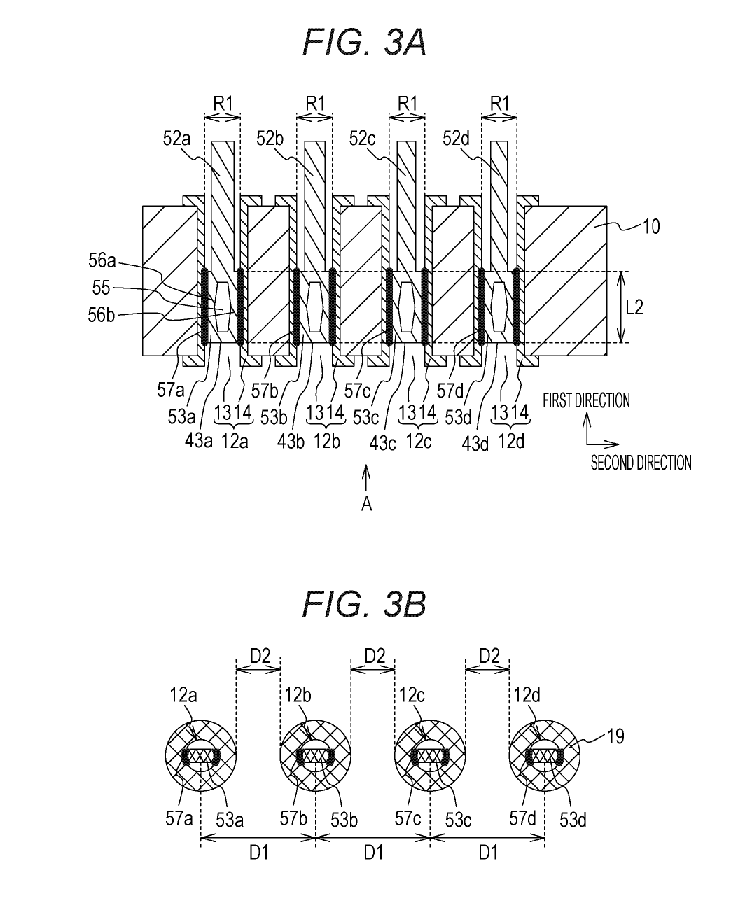

FIG. 3A is an enlarged cross-sectional view of a connecting portion between the connector 50 and the substrate 10 of the first embodiment, and FIG. 3B is a plan view of FIG. 3A as viewed from a direction A. As illustrated in FIGS. 3A and 3B, the one ends 43a to 43d of the terminals 52a to 52d of the connector 50 are inserted into through holes 12a to 12d. At the one ends 43a to 43d, the press-in portions 53a to 53d are provided. The widths of the press-in portions 53a to 53d are larger than the inner diameter R1 of the through holes 12a to 12d, and the terminals 52a to 52d are inserted into the through holes 12a to 12d, whereby the press-in portions 53a to 53d are pressed into the through holes 12a to 12d. Thus, the elastic portions 56a and 56b included in the press-in portions 53a to 53d generate elastic restoring force in the second direction and the outer surfaces of the elastic portions 56a and 56b are brought into pressure contact with the metal layers 14 exposed on the inner surfaces of the through holes 12a to 12d. Therefore, the terminals 52a to 52d are electrically coupled to the through holes 12a to 12d. The portions joined by the terminals 52a to 52d brought into contact with the through holes 12a to 12d are referred to as joined portions 57a to 57d. In FIGS. 3A and 3B, the joined portions 57a to 57d are represented by bold lines. Since all of the lengths L1 of the press-in portions 53a to 53d in the first direction are the same (see FIG. 2B), all of the lengths L2 of the joined portions 57a to 57d in the first direction are the same. The phrase, the lengths L2 are the same, may also mean that the lengths L2 which are different by a degree of manufacturing error are included in the lengths L2 which are the same.

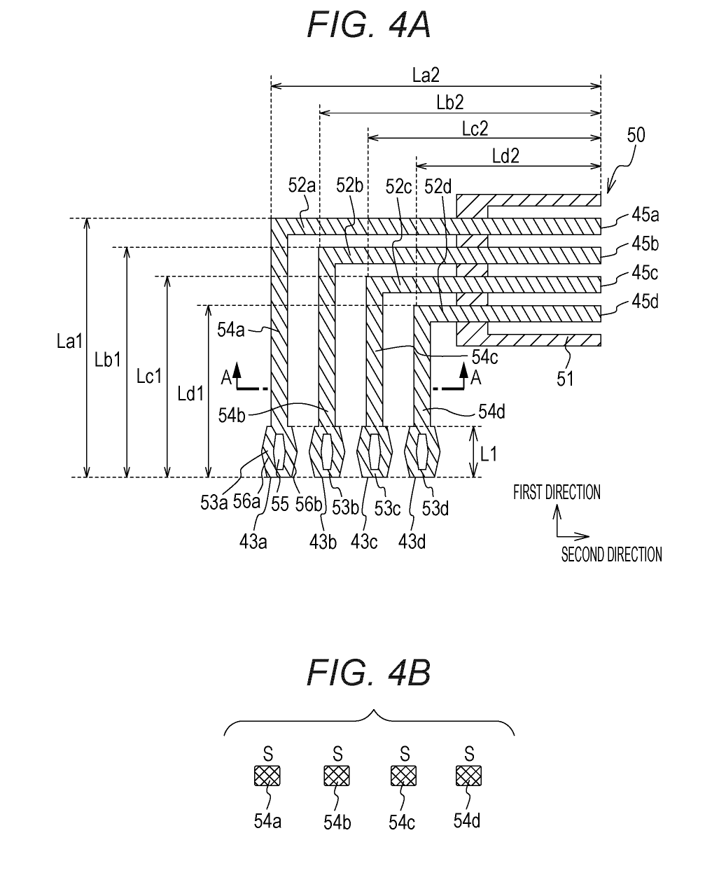

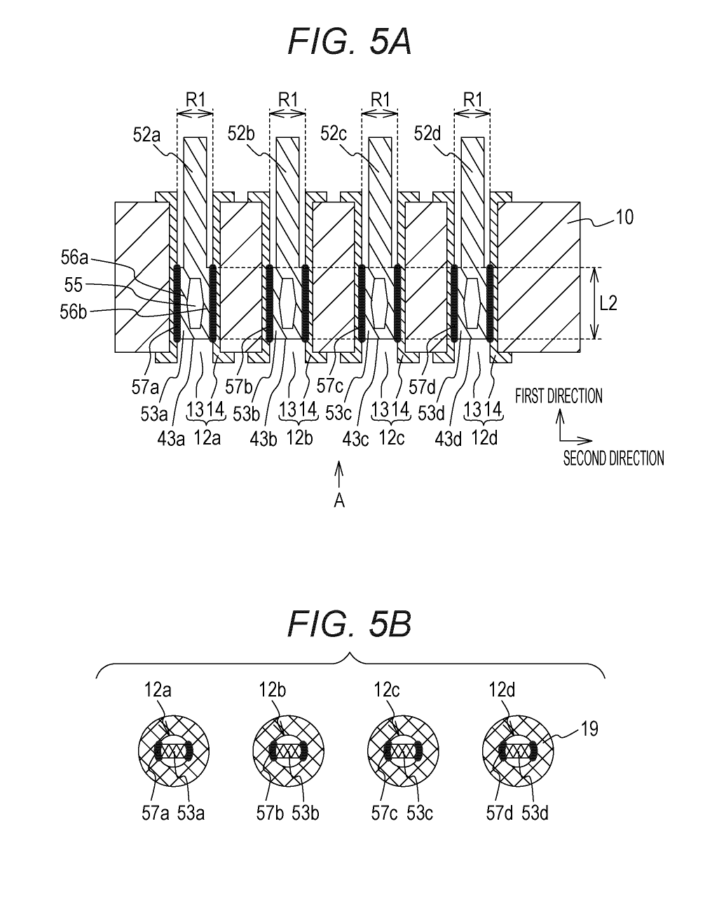

Here, an electronic device according to comparative example 1 will be described. FIG. 4A is a cross-sectional view of a connector 50 of comparative example 1, and FIG. 4B is a cross-sectional view taken along line A-A of FIG. 4A. FIG. 5A is an enlarged cross-sectional view of a connecting portion between the connector 50 and a substrate 10 of comparative example 1, and FIG. 5B is a plan view of FIG. 5A as viewed from a direction A. As illustrated in FIGS. 4A and 4B, in comparative example 1, all of the cross sectional areas of extending portions 54a to 54d included in terminals 52a to 52d of the connector 50 are the same. Here, the cross sectional area of the extending portions 54a to 54d is defined as S. As illustrated in FIGS. 5A and 5B, in comparative example 1, one ends 43a to 43d of the terminals 52a to 52d of the connector 50 are inserted into through holes 12a to 12d similarly to the first embodiment. At the ends 43a to 43d, press-in portions 53a to 53d are provided. Except this point, the structure is the same as that of the first embodiment, so the description is not provided here.

In comparative example 1, the electrical resistances of the extending portions 54a to 54d included in the terminals 52a to 52d can be expressed as follows.

Electrical Resistance Ra of Extending Portion 54a=ρ·(La1+La2−L1)/S

Electrical Resistance Rb of Extending Portion 54b=ρ·(Lb1+Lb2−L1)/S

Electrical Resistance Rc of Extending Portion 54c=p·(Lc1+Lc2−L1)/S

Electrical Resistance Rd of Extending Portion 54d=ρ·(Ld1+Ld2−L1)/S

In the expressions, ρ is conductivities of conductors forming the extending portions 54a to 54d. All of the extending portions 54a to 54d are formed from the same material, and thus all the conductivities ρ of the extending portions 54a to 54d are the same.

As described above, the lengths of the extending portions 54a to 54d satisfy a relationship, the length of the extending portion 54a (La1+La2−L1)>the length of the extending portion 54b (Lb1+Lb2−L1)>the length of the extending portion 54c (Lc1+Lc2−L1)>the length of the extending portion 54d (Ld1+Ld2−L1). Therefore, the electrical resistances of the extending portions 54a to 54d satisfy a relationship, the electrical resistance Ra of the extending portion 54a>the electrical resistance Rb of the extending portion 54b>the electrical resistance Rc of the extending portion 54c>the electrical resistance Rd of the extending portion 54d. Therefore, the electrical resistances of the terminal 52a, the terminal 52b, the terminal 52c, and the terminal 52d become smaller in this order. Since the press-in portions 53a to 53d have the same shape and the same size, the contact resistances (electrical resistances) at the joined portions 57a to 57d are the same.

As described above, in comparative example 1, the electrical resistances of the terminals 52a to 52d are different from each other, generating a distribution in the magnitude of current flowing through the terminals 52a to 52d unfortunately. For example, when the electrical resistance become smaller in the order of the terminal 52a, the terminal 52b, the terminal 52c, and the terminal 52d, the current flowing through the terminal 52a, the terminal 52b, the terminal 52c, and the terminal 52d become larger in this order, applying higher loads in this order.

On the other hand, in the first embodiment, as illustrated in FIG. 2C, the extending portions 54a to 54d have cross sectional areas that are different from each other. Thus, in the first embodiment, the electrical resistances of the extending portions 54a to 54d can be expressed as follows.

Electrical Resistance Ra of Extending Portion 54a=ρ·(La1+La2−L1)/Sa

Electrical Resistance Rb of Extending Portion 54b=ρ·(Lb1+Lb2−L1)/Sb

Electrical Resistance Rc of Extending Portion 54c=ρ·(Lc1+Lc2−L1)/Sc

Electrical Resistance Rd of Extending Portion 54d=ρ·(Ld1+Ld2−L1)/Sd

As described above, the cross sectional areas of the extending portions 54a to 54d satisfy a relationship, the cross sectional area Sa of the extending portion 54a>the cross sectional area Sb of the extending portion 54b>the cross sectional area Sc of the extending portion 54c>the cross sectional area Sd of the extending portion 54d. Therefore, even when the lengths of the extending portion 54a, the extending portion 54b, the extending portion 54c, and the extending portion 54d become shorter in this order, the cross sectional areas become smaller in this order, so that the electrical resistances Ra to Rd of the extending portions 54a to 54d can be made the same.

According to the first embodiment, as illustrated in FIGS. 2A to 3B, the length (La1+La2) of the terminal 52a inserted into and joined to the through hole 12a is longer than the length (Lb1+Lb2) of the terminal 52b inserted into and joined to the through hole 12b. The cross sectional area Sa of the extending portion 54a of the terminal 52a positioned on the side of the other end 45a of the terminal 52a with respect to the joined portion 57a is larger than the cross sectional area Sb of the extending portion 54b of the terminal 52b positioned on the side of the other end 45b of the terminal 52b with respect to the joined portion 57b. Thus, as described above, the electrical resistances of the extending portion 54a and the extending portion 54b can be made the same. In addition, the terminals 52a and 52b are inserted into and joined to the through holes 12a and 12b having the same inner diameter R1. For example, when the sizes of the press-in portions 53a and 53b are made different according to the difference in the cross sectional areas of the extending portions 54a and 54b, the sizes of the inner diameters of the through holes 12a and 12b are different from each other, and the contact areas between the press-in portions 53a and 53b and the through holes 12a and 12b, respectively, become different from each other. In this case, the contact resistance at the joined portion 57a between the terminal 52a and the through hole 12a and the contact resistance at the joined portion 57b between the terminal 52b and the through hole 12b become different from each other. Therefore, even if the difference in electrical resistance between the extending portion 54a and the extending portion 54b become small, due to the difference in contact resistances between the terminals 52a and 52b and the through holes 12a and 12b, respectively, the magnitudes of the current flowing through the terminal 52a and the current flowing through the terminal 52b are different. On the other hand, in the first embodiment, the terminals 52a and 52b are inserted into and joined to the through holes 12a and 12b having the same inner diameter R1. Thus, the contact areas between the press-in portions 53a and 53b and the through holes 12a and 12b, respectively, can be made the same. For example, the contact resistance at the joined portion 57a and the contact resistance at the joined portion 57b can be made the same. Therefore, the sum of the contact resistance at the joined portion 57a and the electrical resistance of the terminal 52a from the joined portion 57a to the other end 45a and the sum of the contact resistance at the joined portion 57b and the electrical resistance of the terminal 52b from the joined portion 57b to the other end 45b can be made the same. Therefore, the difference between the magnitudes of the current flowing through the terminal 52a and the current flowing through the terminal 52b can be reduced.

By making magnitudes of the current flowing from the terminals 52a and 52b to the through holes 12a and 12b, respectively, almost the same, the internal wirings 15 of the substrate 10 can be formed without considering the shapes of the terminals 52a and 52b, reducing the number of design steps.

Further, by making the through holes 12a to 12d have the same inner diameter R1, the gaps between the electrodes 19 can be the gap D2 of the same magnitude when the gaps between the through holes 12a to 12d are the gaps D1 of the same magnitude as illustrated in FIG. 3B. For example, if the inner diameters of the through holes 12a to 12d are different from each other when the gaps between the through holes 12a to 12d are the gaps D1 of the same magnitude, the gaps between the electrodes 19 become different from each other. In this case, when a wiring pattern is provided on the substrate 10 through a space between the electrodes 19, the width of the wiring pattern may be uneven. When this wiring pattern is coupled to the through holes 12a to 12d, a distribution in the magnitudes of the current flowing through the terminals 52a to 52d may be generated due to the influence of the electrical resistance of the wiring pattern. However, by making the through holes 12a to 12d have the same inner diameter R1 as described in the first embodiment, the gaps D2 between the electrodes 19 are made the same. Thus, the width of the wiring pattern through the space between the electrodes 19 can be made even, and generation of a distribution in the magnitudes of the current flowing through the terminals 52a to 52d may be suppressed.

As illustrated in FIG. 3A, it is preferable that the length of the joined portion 57a in the first direction be the same as the length of the joined portion 57b in the first direction. This makes it possible to effectively reduce the difference in electrical resistance (contact resistance) between the terminals 52a and 52b and the through holes 12a and 12b, respectively. Further, as illustrated in FIG. 3A, the fitting force of the terminal 52a to the through hole 12a and the fitting force of the terminal 52b to the through hole 12b may be made almost the same.

As illustrated in FIG. 1, the terminals 52a to 52d of the connector 50 are power supply terminals, to which a power supply voltage is applied from the power supply unit 31 and through which current flows. In this case, large current flows through the terminals 52a to 52d, and thus the effect of making the magnitudes of the current flowing through the terminals 52a to 52d almost the same is great.

### Second Embodiment

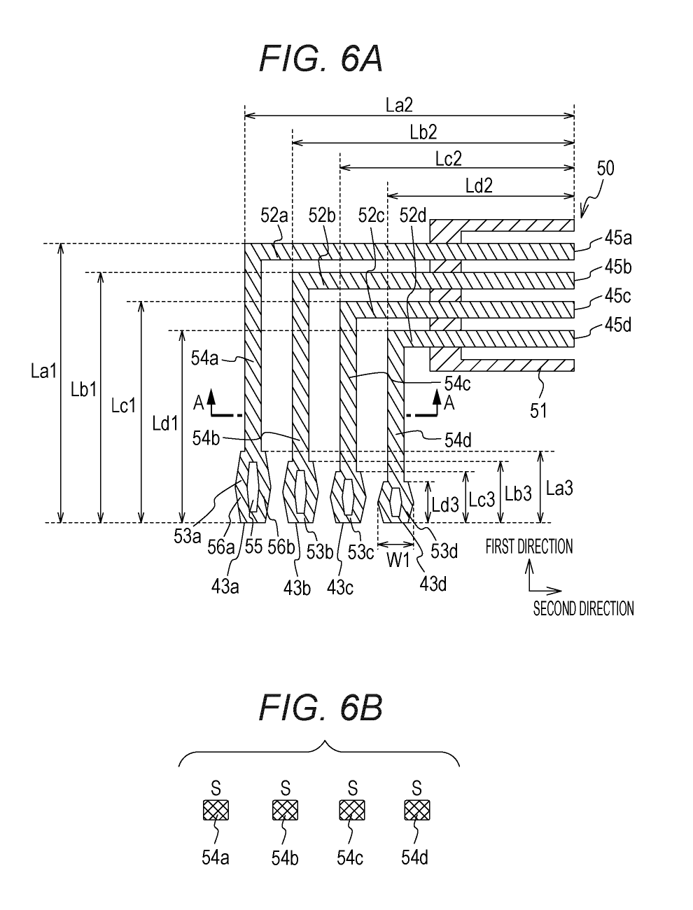

FIG. 6A is a cross-sectional view of a connector 50 of a second embodiment, and FIG. 6B is a cross-sectional view taken along line A-A of FIG. 6A. As illustrated in FIGS. 6A and 6B, in the second embodiment, all of the cross sectional areas of extending portions 54a to 54d included in terminals 52a to 52d of the connector 50 are the same. Here, the cross sectional area of the extending portions 54a to 54d is defined as S. All of the press-in portions 53a to 53d have different shapes and different sizes. When the lengths of the press-in portions 53a to 53d in the first direction are defined as lengths La3 to Ld3, a relationship, the length La3 of the press-in portion 53a>the length Lb3 of the press-in portion 53b>the length Lc3 of the press-in portion 53c>the length Ld3 of the press-in portion 53d, is satisfied. Similarly to the first embodiment, all of the widths W1 of portions of the press-in portions 53a to 53d located in the center thereof in the first direction are the same. The widths W1 are from elastic portions 56a through open holes 55 to elastic portions 56b in the second direction. Except this point, the structure is the same as that of FIGS. 2B and 2C of the first embodiment, so the description is not provided here.

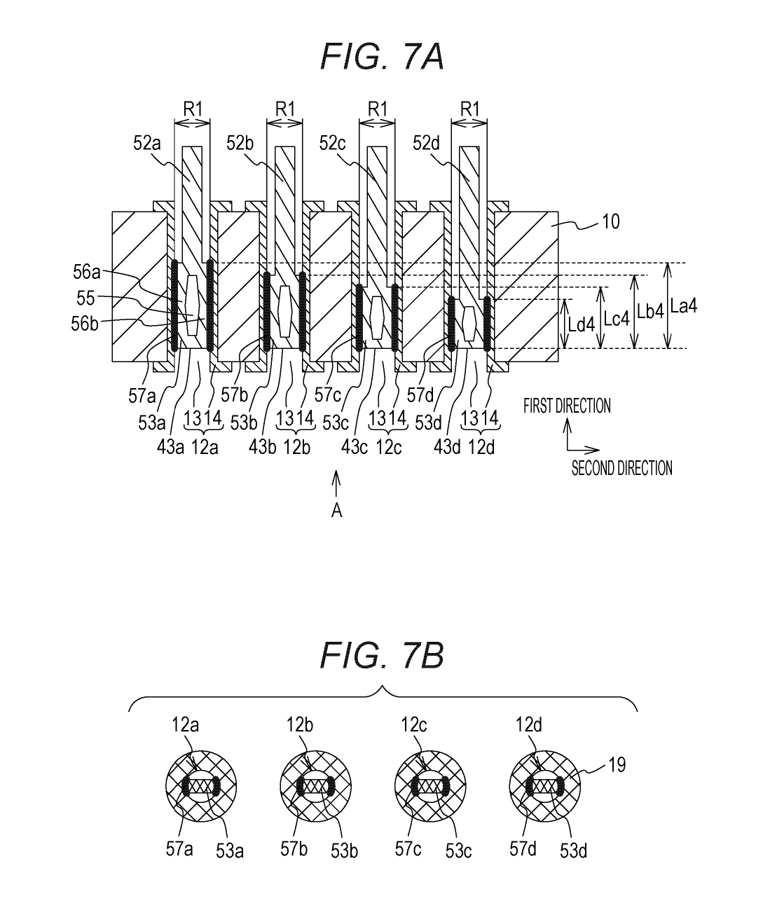

FIG. 7A is an enlarged cross-sectional view of a connecting portion between the connector 50 and a substrate 10 of the second embodiment, and FIG. 7B is a plan view of FIG. 7A as viewed from a direction A. As illustrated in FIGS. 7A and 7B, in the second embodiment, one ends 43a to 43d of the terminals 52a to 52d of the connector 50 are inserted into through holes 12a to 12d similarly to the first embodiment. At the ends 43a to 43d, press-in portions 53a to 53d are provided. Thus, the outer surfaces of the elastic portions 56a and 56b included in the press-in portions 53a to 53d are brought into pressure contact with the metal layers 14 exposed on the inner surfaces of the through holes 12a to 12d, respectively. Thus, the terminals 52a to 52d are electrically coupled to the through holes 12a to 12d. Since the lengths of the press-in portions 53a to 53d in the first direction are different from each other, the lengths of the joined portions 57a to 57d between the terminals 52a to 52d and the through holes 12a to 12d, respectively, in the first direction are different from each other. When the lengths of the joined portions 57a to 57d in the first direction are defined as lengths La4 to Ld4, a relationship, the length La4 of the joined portion 57a>the length Lb4 of the joined portion 57b>the length Lc4 of the joined portion 57c>the length Ld4 of the joined portion 57d, is satisfied. Except this point, the structure is the same as that of FIGS. 3A and 3B of the first embodiment, so the description is not provided here.

In the second embodiment, the electrical resistances of the extending portions 54a to 54d can be expressed as follows.

Electrical Resistance Ra of Extending Portion 54a=ρ·(La1+La2−La3)/S

Electrical Resistance Rb of Extending Portion 54b=ρ·(Lb1+Lb2−Lb3)/S

Electrical Resistance Rc of Extending Portion 54c=ρ·(Lc1+Lc2−Lc3)/S

Electrical Resistance Rd of Extending Portion 54d=ρ·(Ld1+Ld2−Ld3)/S

In addition, as described above, the magnitudes of the current flowing through the terminals 52a to 52d are affected by the contact resistances at the joined portions 57a to 57d. In the second embodiment, since the lengths of the press-in portions 53a to 53d in the first direction are different, the lengths of the joined portions 57a to 57d in the first direction are different, so that the contact resistances are different. Therefore, the contact resistances at the joined portions 57a to 57d are defined as contact resistances Ra1 to Rd1.

In this case, the electrical resistances acting on the current flowing through the terminals 52a to 52d can be expressed as follows.

Electrical Resistance R1 of Terminal 52a=ρ·(La1+La2−La3)/S+Ra1

Electrical resistance of Terminal 52b R2=ρ·(Lb1+Lb2−Lb3)/S+Rb1

Electrical Resistance R3 of Terminal 52c=ρ·(Lc1+Lc2−Lc3)/S+Rc1

Electrical Resistance R4 of Terminal 52d=ρ·(Ld1+Ld2−Ld3)/S+Rd1

All of the inner diameters R1 of the through holes 12a to 12d are the same and the lengths of the joined portions 57a to 57d in the first direction become shorter in the order of the joined portion 57a, the joined portion 57b, the joined portion 57c, and the joined portion 57d. Therefore, the contact resistances Ra1 to Rd1 satisfy a relationship, the contact resistance Ra1<the contact resistance Rb1<the contact resistance Rd<the contact resistance Rd1. Therefore, it can be understood that even when the lengths of the terminal 52a, the terminal 52b, the terminal 52c, and the terminal 52d become shorter in this order, differences between the electrical resistances R1 to R4 of the terminals 52a to 52d can be smaller by making the contact resistance Ra1, the contact resistance Rb1, the contact resistance Rc1, and the contact resistance Rd1 become larger in this order.

According to the second embodiment, as illustrated in FIGS. 6A to 7B, the length (La1+La2) of the terminal 52a inserted into and joined to the through hole 12a is longer than the length (Lb1+Lb2) of the terminal 52b inserted into and joined to the through hole 12b. The length La4 of the joined portion 57a of the terminal 52a in the first direction is longer than the length Lb4 of the joined portion 57b of the terminal 52b in the first direction. Since the terminal 52a is longer than the terminal 52b, the electrical resistance of the terminal 52a tends to be higher. However, by making the joined portion 57a of the terminal 52a longer than the joined portion 57b of the terminal 52b, the contact resistance at the joined portion 57a can be made smaller than the contact resistance at the joined portion 57b. Therefore, the difference between electrical resistances that affect the current flowing through the terminals 52a and 52b may be reduced. Therefore, the difference between the magnitudes of the current flowing through the terminal 52a and the current flowing through the terminal 52b may be reduced.

In addition, according to the second embodiment, as illustrated in FIG. 6A, the cross sectional areas of the other ends 45a to 45d projecting from the front end of the housing 51 of the terminals 52a to 52d are cross sectional areas S of the same magnitude. Thus, the fitting forces of the fitting of the terminals 52a to 52d with terminals 62 of a connector 60 may be made almost the same.

It is preferable that the cross sectional area of the extending portion 54a of the terminal 52a positioned on the side of the other end 45a of the terminal 52a with respect to the joined portion 57a be the same as a cross sectional area of the extending portion 54b of the terminal 52b positioned on the side of the other end 45b of the terminal 52b with respect to the joined portion 57b as illustrated in FIG. 6B. Thus, by adjusting the lengths of the joined portions 57a and 57b, it is possible to easily realize current flowing through the terminals 52a and 52b that are of the same magnitude. Further, since the cross sectional areas of the other ends 45a and 45b projecting from the front ends of the housing 51 of the terminals 52a and 52b are the same, the fitting forces of the terminals 52a and 52b with the terminals 62 of the connector 60 may be made the same.

In the first embodiment described above, the length of the joined portion 57a of the terminal 52a in the first direction and the length of the joined portion 57b of the terminal 52b in the first direction may be different similarly to the second embodiment. For example, the length of the joined portion 57a of the terminal 52a in the first direction may be longer than the length of the joined portion 57b of the terminal 52b in the first direction. Thus, the electrical resistances that affect the current flowing through the terminals 52a and 52b may be adjusted using the two parameters of the cross sectional areas of the extending portions 54a and 54b and the lengths of the joined portions 57a and 57b. Therefore, the electrical resistances can be adjusted with good precision, and the difference between the magnitudes of the current flowing through the terminals 52a and 52b may be effectively reduced.

### Third Embodiment

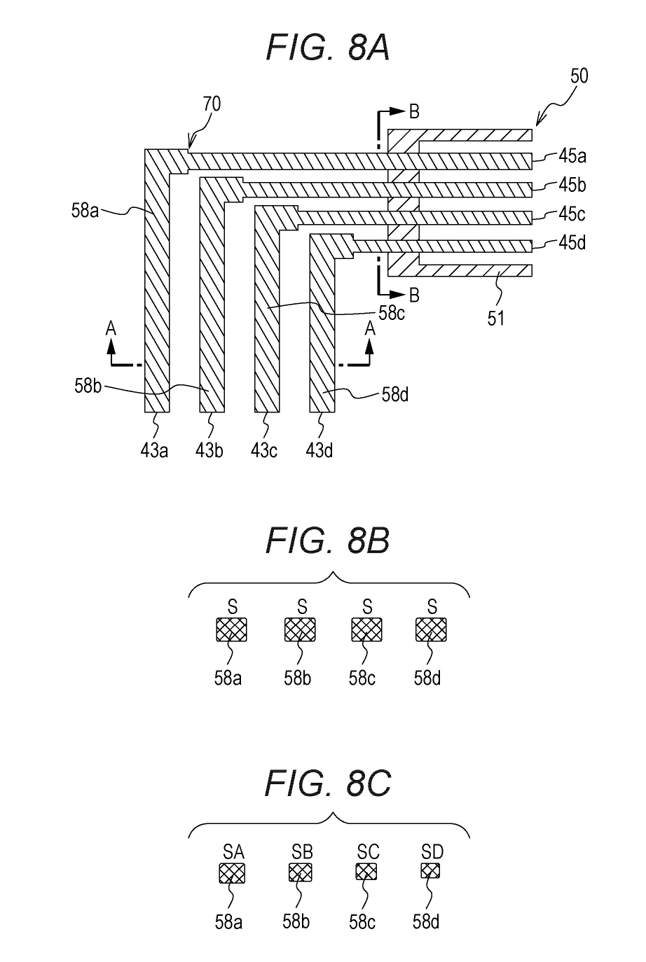

FIG. 8A is a cross-sectional view of a connector 50 according to a third embodiment, FIG. 8B is a cross-sectional view taken along line A-A of FIG. 8A, and FIG. 8C is a cross-sectional view taken along line B-B of FIG. 8A. In the first and second embodiments, cases where the connector 50 is provided with the terminals 52a to 52d that are press-fit terminals having the press-in portions 53a to 53d are illustrated and described as examples. In the third embodiment, as illustrated in FIG. 8A, a connector 50 is provided with terminals 58a to 58d not having press-in portions 53a to 53d. As illustrated in FIGS. 8A to 8C, the terminals 58a to 58d extend such that the cross sectional area does not change to be substantially constant on one ends 43a to 43d to be inserted into through holes 12a to 12d of a substrate 10. The cross sectional area of the terminals 58a to 58d at this portions is defined as S. Each of the terminals 58a to 58d has a stepped portion 70 whose cross sectional area changes between the one ends 43a to 43d to be inserted into the through holes 12a to 12d of the substrate 10 and the other ends 45a to 45d on the opposite side. For example, the terminals 58a to 58d have a stepped structure. On the side of the other ends 45a to 45d of the terminals 58a to 58d with respect to the stepped portions 70, the longer the terminals 58a to 58d are, the larger the cross sectional areas are. For example, a relationship, the cross sectional area SA of the terminal 58a>the cross sectional area SB of the terminal 58b>the cross sectional area SC of the terminal 58c>the cross sectional area SD of the terminal 58d, is satisfied.

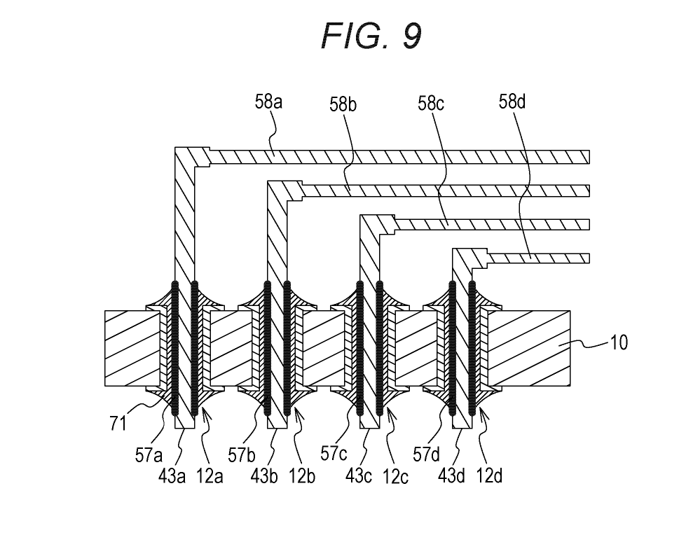

FIG. 9 is an enlarged cross-sectional view of a connecting portion between the connector 50 and the substrate 10 of the third embodiment. As illustrated in FIG. 9, in the third embodiment, the terminals 58a to 58d of the connector 50 are joined to the through holes 12a to 12d of the substrate 10 by solder 71. In this case, the joined portions 57a to 57d joined to the through holes 12a to 12d of the terminals 58a to 58d are portions of the terminals 58a to 58d that are in contact with the solder 71. In FIG. 9, the joined portions 57a to 57d are represented by bold lines.

According to the third embodiment, as illustrated in FIGS. 8A to 8C, the cross sectional area SA on the side of the other end 45a of the terminal 58a is larger than the cross sectional area SB on the side of the other end 45b of the terminal 58b. Thus, even when the terminal 58a is longer than the terminal 58b, the difference in electrical resistance between the terminal 58a and the terminal 58b may be reduced. In addition, as illustrated in FIG. 9, the terminals 58a and 58b are inserted into and joined to the through holes 12a and 12b having the same inner diameter. Thus, the difference between the contact resistances of the joined portions 57a and 57b may be reduced. Therefore, the difference between the magnitudes of the current flowing through the terminal 58a and the current flowing through the terminal 58b may be reduced. Thus, even when the terminals 58a to 58d of the connector 50 are joined to the through holes 12a to 12d of the substrate 10 by the solder 71, it is possible to cause current of almost the same magnitude to flow through the terminals 58a to 58d.

### Fourth Embodiment

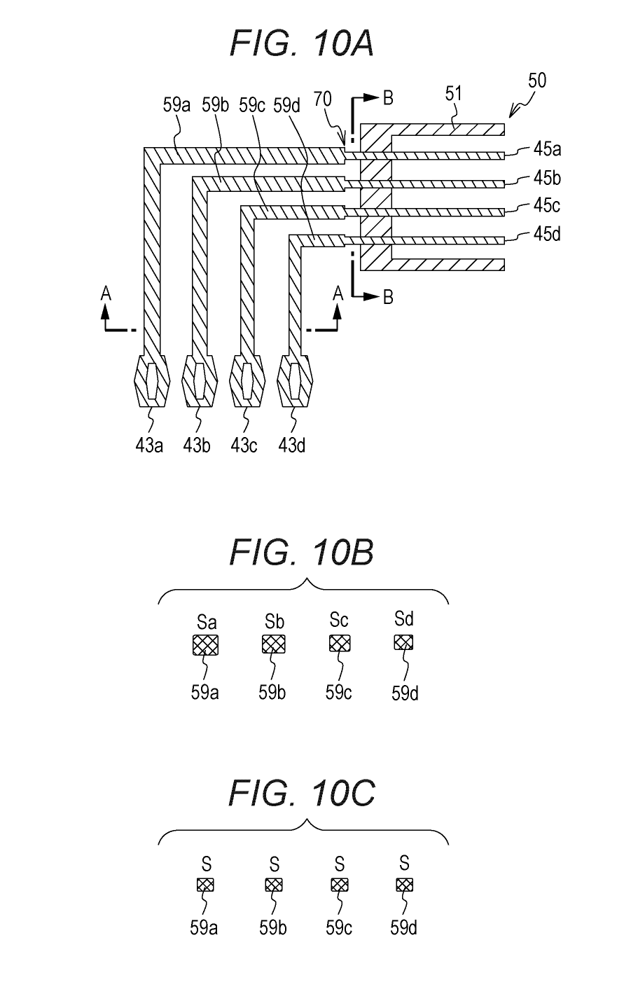

FIG. 10A is a cross-sectional view of a connector 50 according to a fourth embodiment, FIG. 10B is a cross-sectional view taken along line A-A of FIG. 10A, and FIG. 10C is a cross-sectional view taken along line B-B of FIG. 10A. As illustrated in FIG. 10A to FIG. 10C, according to the fourth embodiment, each of terminals 59a to 59d is provided with a stepped portion 70. The cross sectional areas of the terminals 59a to 59d on the side of the one ends 43a to 43d with respect to the stepped portions 70 are defined as cross sectional areas Sa to Sd similarly to the terminals 52a to 52d of the first embodiment. The one ends 43a to 43d are inserted into through holes formed in a substrate 10. For example, a relationship, the cross sectional area Sa of the terminal 59a>the cross sectional area Sb of the terminal 59b>the cross sectional area Sc of the terminal 59c>the cross sectional area SD of the terminal 58d, is satisfied. On the other hand, the cross sectional areas of the terminals 59a to 59d on the side of the other ends 45a to 45d with respect to the stepped portion 70 are sectional areas S of the same magnitude. Except this point, the structure is the same as that of FIGS. 2B and 2C of the first embodiment, so the description is not provided here.

According to the fourth embodiment, the cross sectional areas of the other ends 45a to 45d exposing from the front end of a housing 51 of the terminals 59a to 59d are cross sectional areas S of the same magnitude. Thus, the fitting forces of the fitting of the terminals 59a to 59d with terminals 62 of a connector 60 may be made almost the same. In addition, since the lengths of the joined portions of the terminals 59a to 59d in the first direction are the same, the fitting force of the terminals 59a to 59d to the through holes 12a to 12d may be the same.

In the first to fourth embodiments, cases where a connector is provided as an electronic component with terminals inserted into and joined to through holes of a substrate are illustrated and described, but other electronic components may be used. For example, a semiconductor component having a semiconductor element may be used.

Although the embodiments of the present invention have been described in detail above, the present invention is not limited to such specific embodiments, and various modifications and alternations may be made within the scope of the gist of the present invention described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An electronic component comprising:
a first terminal that is inserted and joined to a first through hole formed in a substrate; and
a second terminal that is inserted into and joined to a second through hole having an inner diameter that is the same as an inner diameter of the first through hole and formed in the substrate, wherein
a length of the first terminal from a first end that is inserted into the first through hole to a second end that is opposite to the first end is longer than a length of the second terminal from a third end that is inserted into the second through hole to a fourth end that is opposite to the third end, and
a cross sectional area of a portion of the first terminal positioned on a side of the second end with respect to a first joined portion at which the first terminal is joined to the first through hole is larger than a cross sectional area of a portion of the second terminal positioned on a side of the fourth end with respect to a second joined portion at which the second terminal is joined to the second through hole.

2. The electronic component according to claim 1, wherein a length of the first joined portion in a direction in which the first terminal is inserted into the first through hole and a length of the second joined portion in a direction in which the second terminal is inserted into the second through hole are the same.

3. The electronic component according to claim 1, wherein a length of the first joined portion in a direction in which the first terminal is inserted into the first through hole and a length of the second joined portion in a direction in which the second terminal is inserted into the second through hole are different.

4. The electronic component according to claim 3, wherein the length of the first joined portion in the direction in which the first terminal is inserted into the first through hole is larger than the length of the second joined portion in the direction in which the second terminal is inserted into the second through hole.

5. The electronic component according to claim 1, wherein a cross sectional area at the second end of the first terminal and a cross sectional area at the fourth end of the second terminal are the same.

6. The electronic component according to claim 1, wherein
in a case where the first terminal and the second terminal are press-fit terminals, the first joined portion is a portion where the first terminal is in contact with the first through hole and the second joined portion is a portion where the second terminal is in contact with the second through hole, and
in a case where the first terminal and the second terminal are joined to the first through hole and the second through hole through solder respectively, the first joined portion is a portion of the first terminal that is in contact with the solder and the second joined portion is a portion of the second terminal that is in contact with the solder.

7. The electronic component according to claim 1, wherein the first terminal and the second terminal are power supply terminals to which current is supplied from a power supply circuit.

8. The electronic component according to claim 1, wherein a sum of a contact resistance at the first joined portion of the first terminal and an electrical resistance of the first terminal from the first joined portion to the second end of the first terminal and a sum of a contact resistance at the second joined portion and an electrical resistance of the second terminal from the second joined portion to the fourth end of the second terminal is the same.

9. The electronic component according to claim 1, wherein
in the first terminal, a width of the first joined portion is larger than a width of a portion of the first terminal on a side of the second end with respect to the first joined portion, and
in the second terminal, a width of the second joined portion is larger than a width of a portion of the second terminal on a side of the fourth end with respect to the second joined portion.

10. The electronic component according to claim 1, wherein the electronic component is a connector.

11. An electronic component comprising:
a first terminal that is inserted into and joined to a first through hole formed in a substrate; and
a second terminal that is inserted into and joined to a second through hole having an inner diameter that is the same as an inner diameter of the first through hole and formed in the substrate, wherein
a length of the first terminal from a first end that is inserted into the first through hole to a second end that is opposite to the first end is longer than a length of the second terminal from a third end that is inserted into the second through hole to a fourth end that is opposite to the third end, and
a length of a first joined portion of the first terminal at which the first terminal is joined to the first through hole in a direction in which the first terminal is inserted into the first through hole is longer than a length of a second joined portion of the second terminal at which the second terminal is joined to the second through hole in a direction in which the second terminal is inserted into the second through hole.

12. The electronic component according to claim 11, wherein a cross sectional area of a portion of the first terminal positioned on a side of the second end with respect to the first joined portion and a cross sectional area of a portion of the second terminal positioned on a side of the fourth end with respect to the second joined portion are the same.

13. The electronic component according to claim 11, wherein
in a case where the first terminal and the second terminal are press-fit terminals, the first joined portion is a portion where the first terminal is in contact with the first through hole and the second joined portion is a portion where the second terminal is in contact with the second through hole, and
in a case where the first terminal and the second terminal are joined to the first through hole and the second through hole through solder respectively, the first joined portion is a portion of the first terminal that is in contact with the solder and the second joined portion is a portion of the second terminal that is in contact with the solder.

14. The electronic component according to claim 11, wherein the first terminal and the second terminal are power supply terminals to which current is supplied from a power supply circuit.

15. The electronic component according to claim 11, wherein a sum of a contact resistance at the first joined portion of the first terminal and an electrical resistance of the first terminal from the first joined portion to the second end of the first terminal and a sum of a contact resistance at the second joined portion and an electrical resistance of the second terminal from the second joined portion to the fourth end of the second terminal is the same.

16. The electronic component according to claim 11, wherein
in the first terminal, a width of the first joined portion is larger than a width of a portion of the first terminal on a side of the second end with respect to the first joined portion, and
in the second terminal, a width of the second joined portion is larger than a width of a portion of the second terminal on a side of the fourth end with respect to the second joined portion.

17. The electronic component according to claim 11, wherein the electronic component is a connector.

18. A substrate formed with a first through hole and a second through hole having the same inner diameter as an inner diameter of the first through hole, the substrate comprising an electronic component including a first terminal inserted into and joined to the first through hole and a second terminal inserted into and joined to the second through hole, wherein
in the electronic component, a length of the first terminal from a first end that is inserted into the first through hole to a second end that is opposite to the first end is longer than a length of the second terminal from a first end that is inserted into the second through hole to a second end that is opposite to the first end, and
one of a first condition in which a cross sectional area of a portion of the first terminal positioned on a side of the second end with respect to a first joined portion at which the first terminal is joined to the first through hole is larger than a cross sectional area of a portion of the second terminal positioned on a side of the second end with respect to a second joined portion at which the second terminal is joined to the second through hole and a second condition in which
a length of a first joined portion of the first terminal at which the first terminal is joined to the first through hole in a direction in which the first terminal is inserted into the first through hole is longer than a length of a second joined portion of the second terminal at which the second terminal is joined to the second through hole in a direction in which the second terminal is inserted into the second through hole is satisfied.
